(19) United States
(12) Patent Application Publication
(10) Pub. No.: US 2025/0199930 A1
(43) Pub. Date: Jun. 19, 2025

(54) SOFTWARE USAGE TRACKING IN A COMPUTING SYSTEM

(71) Applicant: Express Scripts Strategic Development, Inc., St. Louis, MO (US)

(72) Inventor: Debashis Bhattacharjee, St. Louis, MO (US)

(21) Appl. No.: 18/545,694

(22) Filed: Dec. 19, 2023

(51) Int. Cl. G06F 11/34; G06F 16/23

(52) U.S. Cl. CPC G06F 11/34; G06F 16/23; G06F 2201/865

(57) ABSTRACT

Apparatuses, systems, and methods relate to technology to that includes a processor. The technology receives unstructured usage data from applications that execute on user devices, stores the unstructured usage data into a central database, where the unstructured usage data is in an unstructured data format, and retrieves the unstructured usage data from the central database. The technology further converts the unstructured usage data, that is retrieved from the central database, from the unstructured data format into a structured data format to generate structured usage data, stores the structured usage data into a central repository, and generates a current usage measurement based on the structured usage data that is stored in the central repository.

### TECHNICAL FIELD

The present disclosure relates to an enhanced system to track software usage in an automatic fashion. In detail, examples can automatically receive usage data related to software, identify a usage metric based on the usage data and execute an action based on the usage metric.

### BACKGROUND

Software (e.g., applications) can be developed by various parties. The parties can distribute the software to different entities (e.g., enterprises, individual users, non-profit organizations, etc.) that then execute the software. The software can be distributed in different fashions, including peer-to-peer distribution, from a centralized server and/or from third-parties that house the software.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIGS. 1A and 1B are a diagram of an example of an enhanced usage data tracking process according to an example;

FIG. 2 is a diagram of an example of a load automation process according to an embodiment;

FIG. 3 is a diagram of an example of a post-processing process according to an embodiment;

FIG. 4 is a diagram of an example of a cost calculation process according to an embodiment;

FIG. 5 is a diagram of an example of an invocation graph according to an embodiment;

FIG. 6 is a diagram of an example of user graph according to an embodiment;

FIG. 7 is a diagram of an example of invocation usage forecast according to an embodiment;

FIG. 8 is a diagram of an example of an exemplary process according to an embodiment;

FIG. 9 is a diagram of an example of a method according to an embodiment; and

FIG. 10 is a diagram of an example of computing system according to an embodiment;

### DETAILED DESCRIPTION

Software usage can be difficult to accurately assess and track. For example, in conventional examples, software usage tracking is a manually intensive, error prone process that can include manually retrieving usage data from several applications. Each vendor application running in a production environment can have a unique database where statistics are gathered. Gathering, compiling, retrieving and managing historical usage data is a bottle neck in conventional examples. For example, manually produced usage and cost calculation for reporting is time consuming and error prone. Furthermore, doing so also consumes excessive compute resources. For example, usage data may be distributed across various platforms servers, computing devices etc., creating inefficient storage and duplication of various data. Thus, rather than compiling the usage data into one location to avoid duplication, conventional examples can have multiple copies of the same usage data causing excessive memory usage and storage. Furthermore, in some cases, one of the copies can be updated while the others are not updated, causing confusion as to which copy is accurate and leading to further inefficiency.

Thus, conventional manual software usage tracking is inaccurate, time consuming, memory intensive, and creates significant delays. For example, inefficient software license management can significantly affect organizations, impacting both time, hardware resources and overall budgets. This, in turn, affects overall productivity and efficiency. Many organizations still rely on manual methods to manage software licenses and track software usage. Such an archaic approach creates several challenges, including keeping track of acquired licenses, determining which licenses are still necessary, which licenses are unnecessary, leading to inaccuracies when auditing software usage within the organization is employed. Consequently, such manual processes have a detrimental effect on the efficiency and productivity of enterprises. Moreover, mismanagement of licenses exposes organizations to unwanted security risks and liabilities further complicating matters. For example users can assume that security software is operating on computing devices, only to later realize that the software is inactive due to improper licensing procedures and resulting in security lapses and/or breaches. Furthermore, other software can be blocked until licensing requirements for the other software has been met, creating inefficiencies and delays, as well as affecting computing devices throughout an organization.

Examples herein can remove the subjective, error-prone, hardware intensive and inefficient existing processes to create an accurate tracking of software usage (e.g., licenses) with lower hardware overhead and latency. In doing so, security risks are mitigated (e.g., security software is always executing as expected), budgets can be accurately forecasted, memory usage is reduced and users can access software with no delays thereby increasing productivity. Examples herein streamline multiple processes and achieve improved productivity, hardware usage and efficiency.

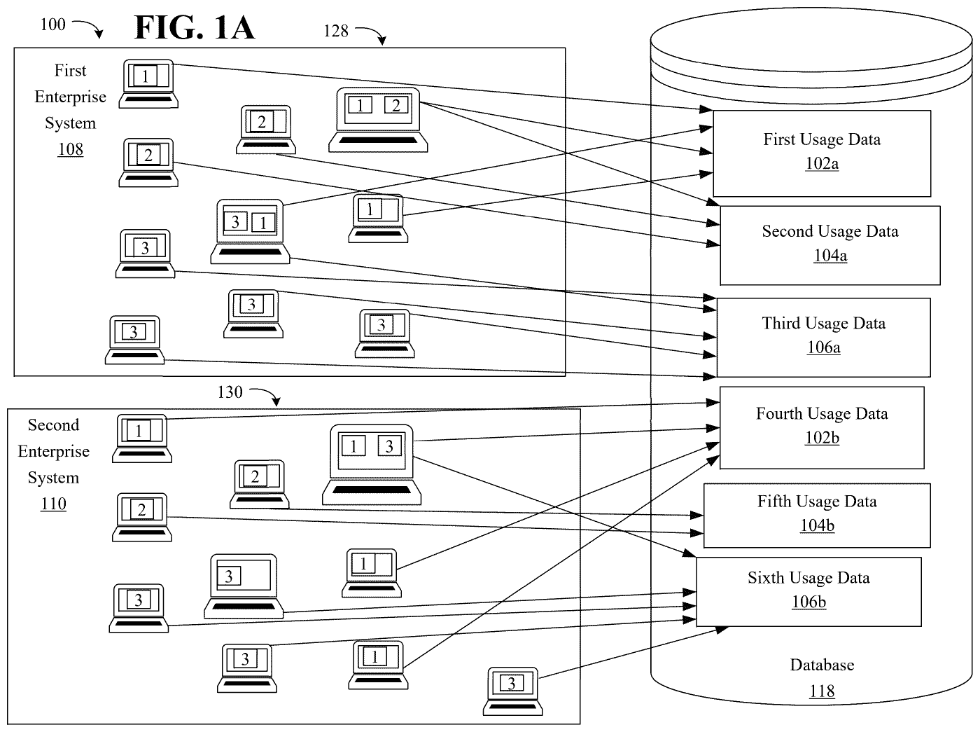

Turning now to FIGS. 1A-1B, an enhanced usage data tracking process 100 is illustrated. The enhanced usage data tracking process 100 includes several enhancements, including a centralized and accurate location to store license tracking software to eliminate duplicative and hardware costly replications of data in a decentralized environment. Examples also accurately track software usage to generate informed decisions about licensing, and whether an enterprise is licensing compliant. Doing so reduces security risks, increases productivity and increases compliance.

Thus, the enhanced usage data tracking process 100 improves at least the technical field of software usage and licensing, and can operate in real-time based on an automated analysis of software usage using computer-implemented rules and models. For example, existing software license tracking can fail to accurately identify how may users and/or invocations of software are executed. Examples herein automatically store software usage metrics (data) into a central repository (even in a distributed system) that can be accessed to achieve accurate measurements of software usage. For example, in order to accomplish the enhancements herein, examples receive unstructured usage data from applications that execute on user devices, store the unstructured usage data into a central database, where the unstructured usage data is in an unstructured data format, retrieve the unstructured usage data from the central database, convert the unstructured usage data, that is retrieved from the central database, from the unstructured data format into a structured data format to generate structured usage data, store the structured usage data into a central repository, and generate a current usage measurement based on the structured data that is stored in the central repository.

In this example, two different enterprises, first enterprise system 108 and second enterprise system 110, are illustrated. First enterprise system 108 includes first computing devices 128. The first computing devices 128 can be servers, mobile devices, laptops, desktops, personal device assistants, etc. The first computing devices 128 can execute first-third applications. The first application is denoted with a “1,” the second application is denoted with a “2” and the third application is denoted with a “3” in FIG. 1A.

The first, second and third applications include tracking software to identify when the first, second and third applications are activated, invoked and/or utilized (e.g., invocations, used on a user device, etc.). When the first, second and third applications are identified as activated, invoked and/or utilized, the tracking software stores an indication of the activation, invocation and/or utilization into database 118 as first usage data 102a, second usage data 104a and third usage data 106a respectively. For example, the first usage data 102a includes activations, invocations and/or utilizations of the first application by the first computing devices 128. The second usage data 104a includes activations, invocations and/or utilization of the second application by the first computing devices 128. The third usage data 106a includes activations, invocations and/or utilization of the third application by the first computing devices 128.

The activations, invocations and/or utilizations of the first-third applications can be correspondingly grouped together in the database 118 (e.g., a central database). For example, the first usage data 102a can only include usage data (e.g., activations, invocations and/or utilization) of the first application. The second usage data 104a can only include usage date (e.g., activations, invocations and/or utilization) of the second application. The third usage data 106a can only include usage date (e.g., activations, invocations and/or utilization) of the third application. Therefore, the usage data of the first-third applications can be divided from each other, aggregated and stored in the database 118.

The database 118 can be in the cloud. Doing so provides several enhancements, such as providing a central location for all relevant application usage data. In doing so, multiple locations on the first enterprise system 108 and second enterprise system 110 need not be accessed and searched. For example, a third-party that generated the first-third application can have limited or no access to the first enterprise system 108 and the second enterprise system 110. Therefore, if usage data is stored on the first enterprise system 108, 110, the third-party would be unable to access the usage data, leading to inaccurate usage metrics. Moreover, even if the third-party was able to access the first enterprise system 108 and the second enterprise system 110, the usage data could be stored in multiple locations causing inefficiencies, increasing bandwidth to access the locations and leading to possible inaccuracies. Moreover, usage data stored on the first enterprise system 108 and second enterprise system 110 can potentially be accessed and modified by nefarious actors and/or accidently by unsuspecting users. As such, examples provide the database 118 (e.g., a central database) accessible to both the first enterprise system 108 and second enterprise system 110 (e.g., limited permission to write new data but not overwrite stored data), enabling an efficient, secure and seamless way for both the first enterprise system 108 and second enterprise system 110 to store usage data into the database 118 in real-time. Any data that is transmitted to the database 118, such as the first usage data 102a, second usage data 104a, third usage data 106a can be hashed and/or encrypted to mitigate sensitive information (e.g., personally identifiable information, serial numbers, etc.) from being compromised in transit. The database 118 can decrypt the received data.

In some examples, the first enterprise system 108 and second enterprise system 110 can be controlled by first and second enterprise respectively. The first-third applications can be associated with (e.g., controlled and/or owned by) a third enterprise (e.g., the third-party) that generated the first-third applications. The third enterprise can seek to determine when the first-third applications are being used, and metrics related to usage (e.g., duration of usage, invocations, how many users used the first-third applications, etc.). As such, the usage data can be provided directly to the third enterprise and stored in the database 118. The database 118 can be a cloud-based storage as noted above.

The second enterprise system 110 includes second computing devices 130 (e.g., laptops, servers, desktop computers, mobile devices, personal device assistants, etc.). The second computing devices 130 can also execute the first-third applications. Usage data of the first-third applications on the second computing devices 130 can be stored as fourth usage data 102b (e.g., stores data only related to the first application), fifth usage data 104b (e.g., stores data only related to the second application) and sixth usage data 106b (e.g., stores data only related to the third application). The process to generate the fourth usage data 102b, fifth usage data 104b and sixth usage data 106b is similar to as described above with respect to the first enterprise system 108, and will be omitted for brevity.

The first usage data 102a, second usage data 104a, third usage data 106a, fourth usage data 102b, fifth usage data 104b and sixth usage data 106b can be stored on the database 118. Thus, according to examples herein, usage data (e.g., invocations and/or consumer interactions) can be tracked across first enterprise system 108 and second enterprise system 110 (e.g., different enterprises) through the database 118 that serves as a central location to store usage data. In doing so, total application usage across multiple, distinct and separate platforms is achieved in real-time and accelerated efficiency.

Turning now to FIG. 1B, a server 120, which can be hosted by the third enterprise, connects to the database 118 to retrieve data from the database 118. The server 120 can execute data load automator 122 in some examples. The database 118 can contain the first usage data 102a, second usage data 104a, third usage data 106a, fourth usage data 102b, fifth usage data 104b and sixth usage data 106b in a table where the first-third applications store interactions for service invocations and users. The server 120 connects applications through web services, and the database 118 returns response of the web service and flat files containing usage data generated in the server 120 for each of the first-third applications. The server 120 can aggregate different data together and categorize the data based on particular criteria (e.g., monthly usage, application specific data, monthly application use, etc.).

The data load automator 122 can execute operations on the first usage data 102a, second usage data 104a, third usage data 106a, fourth usage data 102b, fifth usage data 104b and sixth usage data 106b. In order to do so, the data load automator 122 can maintain a master copy of first usage data 102a, second usage data 104a, third usage data 106a, fourth usage data 102b, fifth usage data 104b and sixth usage data 106b on the database 118, and create a modifiable version of the first usage data 102a, second usage data 104a, third usage data 106a, fourth usage data 102b, fifth usage data 104b and sixth usage data 106b. The format of the modifiable version can be adjusted from an unstructured format to a relational database format (e.g., structured query language) to facilitate low latency operations.

For example, the modifiable version (e.g., unstructured usage data) can initially be in an unstructured format. An unstructured format can be a dataset (typical large collections of files and can be in comma-separated values format) that is not stored in a structured database format to be not have a predefined data model (e.g., can be stored in a non-relational database). The unstructured usage data can correspond to one or more of invocations of the first-third applications or a number of users of the first-third applications. Further, the modifiable version can include different data formats. The data load automator 122 can modify the modifiable version to convert the modifiable version from the unstructured format to a structured format and generate structured data that is in a structured data format. A structured data format can be quantitative data that is organized and easily analyzed by computing systems. For example, a structured data format can be compatible with and managed with a structured query language (SQL) programming language. Structured data can be stored in a relational database.

In this example, the modifiable version, that is in the structured format, is then stored in the data lake repository 124. The data lake repository 124 can be a relational database that is able to store data efficiently in a form predisposed for certain functions. A report 126 can provide a visual display of the modifiable version. The report 126 can also be a pre-defined layout of the modifiable version based on multiple table joins (e.g., combines tables relating to application 1 over a certain time period).

A function executor 132 can create a visual display, execute certain functions to identify metrics of usage (e.g., increase, decrease, cost, licensing, etc.) based on the modifiable version. For example, the visual display can be presented on a graphical user interface of a computing device. The visual display can have numerous views. For example, the views can include a usage by application view that illustrates each of the first, second and third application separately. For example, data of the modifiable version that corresponds to the first usage data 102a and the fourth usage data 102b can be combined to generate an overall view of the first application. Similarly, data of the modifiable data that corresponds to the second usage data 104a and fifth usage data 104b can be combined to generate an overall view of the second application. Data of the modifiable data that corresponds to the third usage data 106a and sixth usage data 106b can be combined to generate an overall view of the third application. In some examples, the first usage data 102a, second usage data 104a, third usage data 106a, fourth usage data 102b, fifth usage data 104b and sixth usage data 106b can be separately analyzed to determine enterprise specific usage models.

The views can also include a usage amount view for all of the first, second and third applications. The usage amount view can include usage by year (e.g., usage amount for entire year). The views can also include a usage by year for an entire organization such as one of the first and second enterprises 108, 110. The usage by year can include the usage amount for an entire company each year.

The views can be granular as well. For example, one of the views can be the usage for an entire division of first enterprise system 108 and/or second enterprise system 110. For example, every organization may have divisions which utilize the first, second and/or third applications. Such a report can be for one of the divisions.

The views can also include a forecast report of usage for the first, second and third applications by year. The forecast report can be based on an increase in usage of one of the first, second and third applications over a period of time. The increase in usage can be used to forecast the future usage of the first, second and third applications. In some examples, copies of the first, second and third applications and/or associated functions that execute actions for the first, second and third applications can be pre-emptively stored at various servers proximate to enterprises that are projected to download and/or utilize the first, second and third application based on the forecast.

For example, a first server can be disposed proximate to the first enterprise system 108. The first enterprise system 108 can be projected to download the first application a significant (e.g., one-thousand times next month) based on the increase in usage (e.g., based on the forecast report). Examples can preemptively store a copy of the first application on the first server to facilitate low latency downloads of the first application. Conversely, if the second application is projected to be infrequently downloaded by the first enterprise system 108 and frequently downloaded by the second enterprise system 110, the second application can be stored at a second server proximate to the second enterprise system 110 and farther away from the first enterprise system 108 to reduce hardware resources while facilitating low latency downloads of the second application for the most frequent users of the second application. Some examples can include usage predictions for a next five years for the first, second and third applications.

In some examples, if the usage data (e.g., how many computers use an application of the first-three applications) is greater than an amount allotted to a respective enterprise of the first enterprise system 108 or the second enterprise system 110, some of the computing devices of the respective enterprise can be deactivated. For example, suppose that the first usage data 102a indicates that fifty users are using the first application from the first enterprise system 108. Further suppose that only 45 users are licensed to use the first application. Examples can notify the first enterprise system 108 that five more users should be licensed, and/or deactivate five copies of the application from executing on the first enterprise system 108 (e.g., block the five copies from executing).

Some examples can include displays to forecast report of usage for organizations by year. For example, the usage prediction for the next five years for entire organizations can be predicted and visualized.

Some views can also include cost database views. For example, a license cost for applications can be visualized, and a total license cost for each application of the first-third applications.

Some views can include license cost or entire year for all applications of the first-third applications. For example, a total license cost for an entire year may be visualized.

A license cost for an entire organization can also be visualized. For example, a total license cost for entire organization can be illustrated. Further, a license cost for entire division can be visualized. For example, a license cost for an entire division comprises of first-third applications. Further, a license cost forecast report of usage for applications by year can be visualized. Moreover, a license cost forecast report of usage for organization by year can be visualized.

In some examples, new data is provided to the database 118 in real-time. That is, updates to the data in the database 118 can occur at any time. The new data can be periodically identified by the server 120, retrieved and analyzed.

In some examples, the server 120 only retrieves data that is marked as “new.” For example, to reduce resource consumption such as bandwidth, power and processing (e.g., hardware) resources, examples retrieve first data of the data stored in the database 118 based on a first flag, where the first flag indicates that the first data was previously unretrieved by the server 120. The server 120 can bypass retrieving second data from the database 118 based on a second flag, where the second flag indicates that the second data was previously retrieved by the server 120. That is, the second data was previously analyzed by the server 120 and/or the data load automator 122. As such, some examples only analyze data that previously was not retrieved or analyzed by the server 120 and/or data load automator 122. For example, when new data is placed into the database 118, a flag for the new data can be set to a value indicating that the data is new. When the server 120 periodically scans the database 118, the server 120 can identify that the new data has not been analyzed and/or retrieved based on the flag. Thus, based on the flag, the new data can be retrieved by the server 120 and analyzed by the data load automator 122. Thereafter, the flag can be set to a different value to indicate that the new data was retrieved and analyzed. Thereafter, the new data will no longer be retrieved by the server 120 and/or analyzed by data load automator 122 since the flag indicates that the new data was previously retrieved.

Any and all of the components described herein can be connected through various networks. The network(s) connecting the first enterprise system 108, second enterprise system 110, database 118, server 120, data load automator 122, data lake repository 124, report 126, first computing devices 128, second computing devices 130 and function executor 132, can include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology. Furthermore, the database 118, server 120, data load automator 122, data lake repository 124, report 126 and function executor 132 can be controlled by the third enterprise.

Aspects of the enhanced usage data tracking process 100 can be implemented in logic instructions (e.g., software), configurable logic, fixed-functionality hardware logic, computer readable instructions stored on at least one non-transitory computer readable storage medium that are executable to implement the enhanced usage data tracking process 100, circuitry, etc., or any combination thereof. The enhanced usage data tracking process 100 can be a computing architecture, in which any of the components are executed in logic instructions (e.g., software), configurable logic, fixed-functionality hardware logic, computer readable instructions stored on at least one non-transitory computer readable storage medium that are executable to implement the on enhanced usage data tracking process 100, circuitry, etc., or any combination thereof.

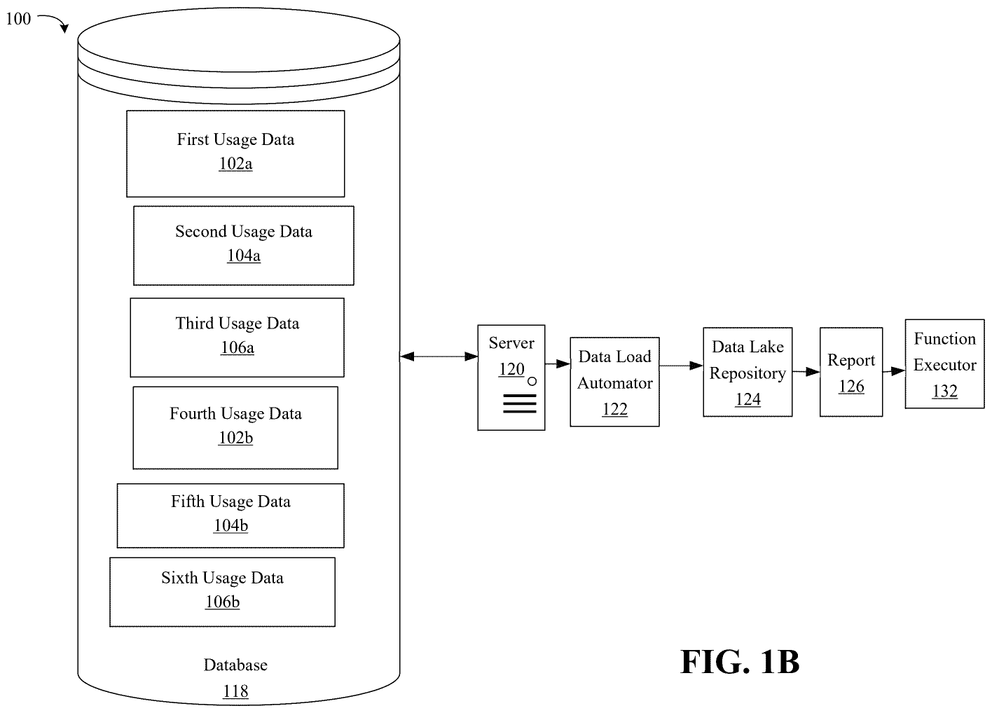

Turning now to FIG. 2, a load automation process 150 is illustrated. The load automation process 150 can be readily implemented by and/or substituted for the data load automator 122 (FIGS. 1A-1B). The load automation process 150 can generally be implemented in conjunction with any of the embodiments described herein, for example the enhanced usage data tracking process 100 (FIGS. 1A-1B). Similar aspects to the enhanced usage data tracking process 100 (FIGS. 1A-1B) are omitted for the sake of brevity, but it will be understood that aspects of load automation process 150 can be implemented similarly to corresponding aspects of the enhanced usage data tracking process 100 (FIGS. 1A-1B).

A data load automator 160 can execute automated actions. A scheduled task 152 executes the automation periodically (e.g., monthly, daily, hourly, etc.) to extract unstructured data from a first database, such as the database 118 (FIGS. 1A-1B), into multiple files and load the multiple files into a shared server directory 154 (e.g., a second database). The unstructured data can be stored in an unstructured data format. The data load automator 160 can be implemented with a server, such as server 120 (FIG. 1B), that extracts data from the first database and stores the unstructured data into database tables. Each file can represent an application, and in the first database each application has separate tables.

The data load automator 160 copies the unstructured data from the shared server directory 154 to a temporary server directory 156. The unstructured data can be modified in the temporary server directory 156 to create structured files 162 (e.g., structured query language and/or another the structured data format) and stores the structured files 162 in the temporary server directory 156.

The data load automator 160 can connect to a data lake repository 158 and store the structured files 162 into multiple tables corresponding to different applications. Each usage file of the structured files 162 can be stored into a corresponding table that corresponds to a relevant field (e.g., application one data, application two data, etc.) based on characteristics of the usage file. For example, a usage file that includes data for application one can be stored into a table that includes data for application one. Other criteria can exist for tables and data storage.

Thus, examples can copy the unstructured data (e.g., unstructured usage data) into the temporary server directory 156 (e.g., a temporary database). Examples can further store the structured data (e.g., structured usage data) into the temporary server directory 156 (e.g., a temporary database). To convert the unstructured data from the unstructured data format into the structured data format, examples modify the unstructured usage data that is stored in the temporary server directory 156.

In some examples, there can be a notifications (e.g., emails, texts and/or other alerts) during load automation process 150. For example, a notification of the scheduled task 152 and/or completion of the scheduled task 152 with logs can be used to identify issues. The data files, such as structured files 162, can be provided as attachments in notification emails for example.

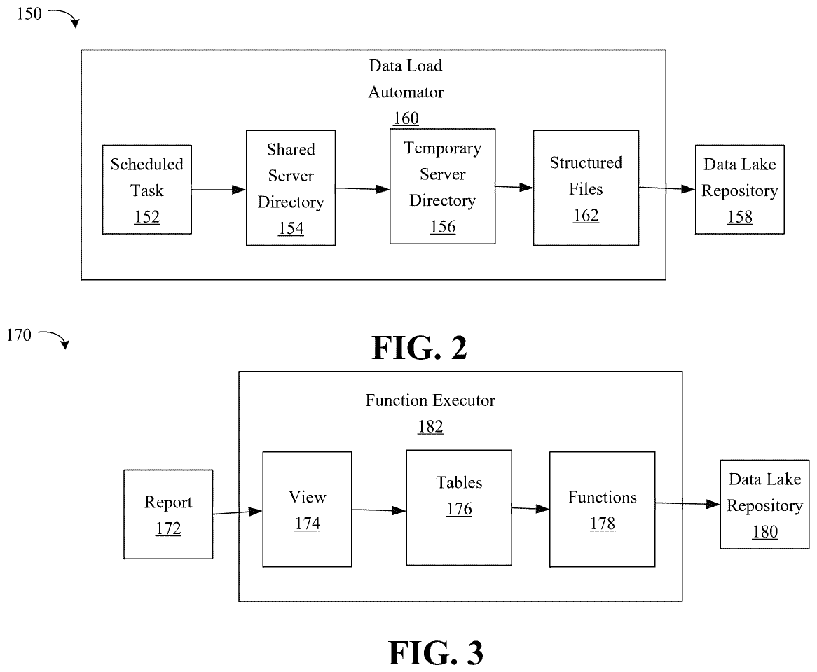

FIG. 3 illustrates a post-processing process 170. The post-processing process 170 can generally be implemented in conjunction with any of the embodiments described herein, for example enhanced usage data tracking process 100 (FIGS. 1A-1B) and load automation process 150 (FIG. 2). The post-processing process 170 can execute functions on structured data. The post-processing process 170 includes a function executor 182 that can be readily substituted for the function executor 132 (FIG. 1B), a report 172 that can be readily substituted for the report 126 (FIG. 1B) and a data lake repository 180 that can correspond to data lake repository 124 (FIG. 1B). In this example, a report 172 is provided to the function executor 182. The function executor 182 can generate a view 174 of the report 172 (e.g., display different view of the data related to application usage). The report 172 can include several reports that correspond to multiple views of the view 174. The view 174 interacts with tables 176 (e.g., mapping tables, application usage tables, etc.) for enterprise (e.g., organization) and consolidated view (e.g., used dematerialized view) that shows all applications usage tables. The tables 176 automatically identify an application name, organization, divisions and other data using functions 178.

In a database, there are numerous database views that can be created to build the report 172. For example, interactions of services those built inside applications and users and application usage data can be combined in a materialized view to save performance on loading data. A reporting database that stores the report 172 can be a non-relational or relational database. The application usage data is separated from each other to feed the application data into the view 174 properly and for simplicity. Some calculations of the application data can be made through functions 178 (e.g., database functions) so that dynamically assigned values inside the tables 176 can be presented. The output of the functions 178 can be stored in a data lake repository 180.

During post-processing process 170, notifications can be provided. For example, during a data load automation, details of any applications data that is attempted to be inserted into data lake repository 180 and failed is provided.

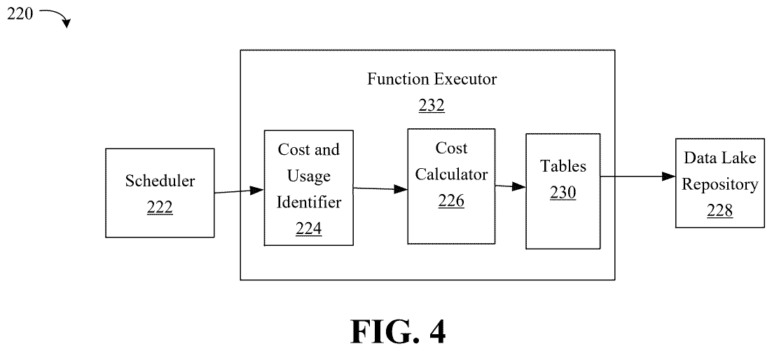

FIG. 4 illustrates a cost calculation process 220, The cost calculation process 220 includes a function executor 232 that can be readily substituted for the function executor 132 (FIG. 1B). The cost calculation process 220 can generally be implemented in conjunction with any of the embodiments described herein, for example enhanced usage data tracking process 100 (FIGS. 1A-1B), load automation process 150 (FIG. 2) and/or post-processing process 170 (FIG. 3). Cost can be calculated programmatically with low latency, or at a later time (e.g., based on user availability of the report) after a usage data determination, A usage cost rate can be determined every year based on relevant data (e.g., contractual obligations) and the attribute cost rate can be monthly or yearly. A database usage cost table can be built to maintain the cost rates. After calculation, the cost can be stored in multiple tables if so desired. In the cost calculation process 220, the scheduler 222 separates scheduled tasks that runs the cost and usage identifier 224 to obtain the cost and usage data from a data lake repository 228. The cost calculator 226 can retrieve the cost and usage data from the cost and usage identifier 224 to generate a total cost, and stores the total cost into tables 230. The tables 230 are then stored into the data lake repository 228.

In some examples, the tables 230 can be used to generate various reports. The reports can be broken down to make many reusable reports for usage data and cost data. For example, a usage count for an entire company can be used to determine license cost. If the company has several divisions, and the report can reflect division-specific usage reports (e.g., licenses-per-division and cost-per-division).

Below are some examples of database views to illustrate pictures for usage and license cost. For example, a cost database view can include license cost for applications. Another view can include a total license cost for each application and a license cost for each application or entire yearly cost for all applications. Another view can include the total license cost for entire year. Another view can include a license cost for an entire organization. For example, the view can include a total license cost for entire organization.

Another view can include a license cost for an entire division. For example, a license cost for an entire division can include a licensing cost for all applications. Some examples can include a license cost forecast report of usage for applications by year. Some examples can also include a license cost forecast report of usage for organizations by year.

In some examples, the report can be of different types based on the desire. Some example reports are provided below. There are different approaches which can integrate with databases and present the report. The below reports are examples. For example, a view can include a usage cost by month, for example a, monthly usage cost for applications. Another view can include a yearly usage cost by application, for example a yearly usage cost for each application. Another view can include a monthly usage cost by application, for example a monthly usage cost for each application. Another view can include monthly usage cost by division, for example monthly usage cost for each division. Another view can include a yearly usage cost by division, and in particular a yearly usage cost for each division.

A notification can be made during cost calculation process 220. While calculating cost, examples can send cost report notification with any changes in cost from the previous month.

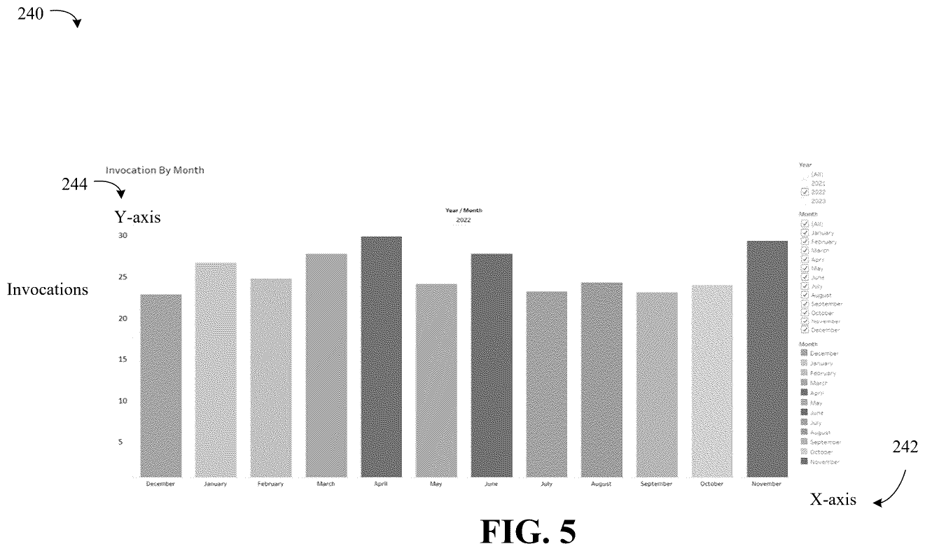

FIG. 5 illustrates an invocation graph 240 of invocations per month. The invocation graph 240 can be readily substituted for the view 174 (FIG. 3). The invocation graph 240 can generally be implemented in conjunction with any of the embodiments described herein, for example enhanced usage data tracking process 100 (FIGS. 1A-1B), load automation process 150 (FIG. 2), post-processing process 170 (FIG. 3) and/or cost calculation process 220 (FIG. 4).

As illustrated, the total number of invocations of a software application are tracked over the course of a month. The invocations (e.g., the dependent variable) are plotted along the Y-axis 244, while the months (e.g., the independent variable) are plotted along the X-axis 242.

The invocation graph 240 can be used to determine costs, licensing, whether to generate extra copies of the application in different servers to facilitate anticipated low-latency downloads to different customer sites that exhibit a number of invocations above a threshold, etc.

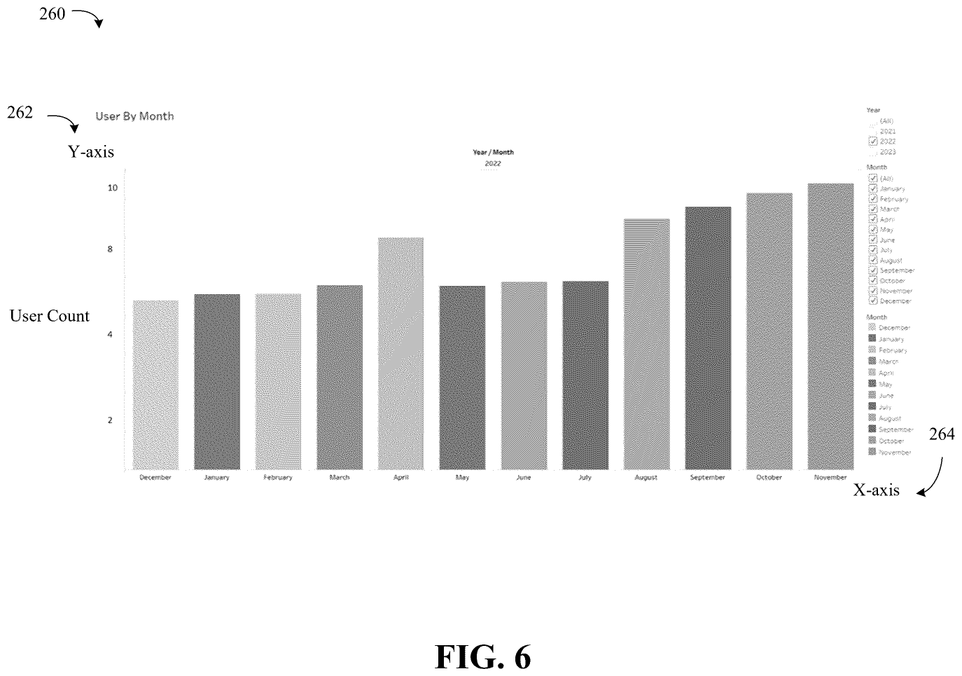

FIG. 6 illustrates a user graph 260 of users per month. The user graph 260 can be readily substituted for the view 174 (FIG. 3). The user graph 260 of can generally be implemented in conjunction with any of the embodiments described herein, for example enhanced usage data tracking process 100 (FIGS. 1A-1B), load automation process 150 (FIG. 2), post-processing process 170 (FIG. 3), cost calculation process 220 (FIG. 4) and/or invocation graph 240 (FIG. 5).

As illustrated, the total number of users of a software application are tracked over the course of several months. The users (e.g., the dependent variable) are plotted along the y-axis 262, while the months (e.g., the independent variable) are plotted along the x-axis 264.

The user graph 260 can be used to determine costs, licensing, whether to generate extra copies of the application in different servers to facilitate anticipated low-latency downloads to different customer sites that exhibit a number of invocations above a threshold, etc.

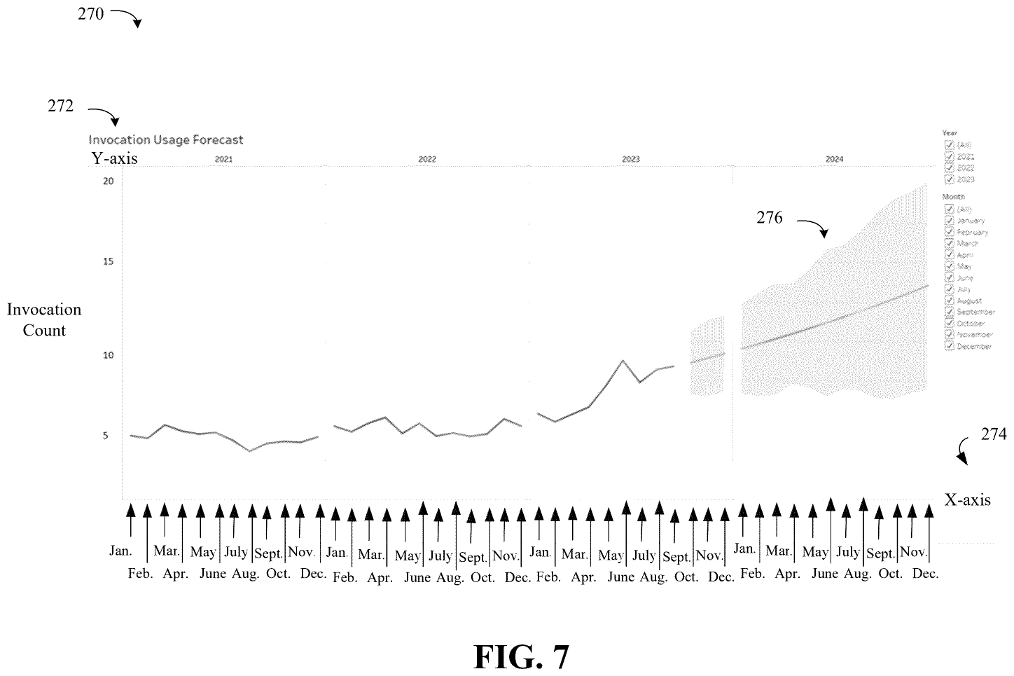

FIG. 7 illustrates invocation usage forecast 270 in a format. The invocation usage forecast 270 can be readily substituted for the view 174 (FIG. 3). The invocation usage forecast 270 can generally be implemented in conjunction with any of the embodiments described herein, for example enhanced usage data tracking process 100 (FIGS. 1A-1B), load automation process 150 (FIG. 2), post-processing process 170 (FIG. 3), cost calculation process 220 (FIG. 4), invocation graph 240 (FIG. 5) and/or user graph 260 (FIG. 6).

As illustrated, the total number of users of a software application are tracked over the course of several months. The invocations (e.g., the dependent variable) are plotted along the Y-axis 272, while the months (e.g., the independent variable) are plotted along the X-axis 274. The invocation usage forecast 270 includes a predicted portion 276 that predicts behavior of the invocations in the future. To do so, examples can model the invocations over a period of time (e.g., from January 2021-September 2023). Examples may then predict future invocations of the predicted portion 276 (e.g., a number of invocations per month of 2024) through different techniques, including machine learning, artificial intelligence, regression analysis, etc.

In some examples, the predicted portion 276 further corresponds to a geographical area. For example, the invocations may originate within the geographical area. Copies of the software application may be placed into servers (or other computing devices) within the geographic area to facilitate low-latency downloads, reduce bandwidth and increase efficiency. Furthermore, hardware resources in the geographical area may be predictively dedicated (e.g., the hardware resources only execute operations dedicated to the software application) to operations associated with the invocations (e.g., the hardware resources are allocated prior to the predicted invocations occurring) based on the predicted portion 276. In such an instance, different invocation usage forecasts may be generated for different geographical areas to identify which geographical areas would benefit from more hardware resources dedicated to the software.

Thus, the predicted portion 276 can be used to determine costs, licensing, whether to generate extra copies of the application in different servers to facilitate anticipated low-latency downloads to different customer sites that exhibit a number of users above a threshold, etc. In some examples, different actions may be executed in response to actual reports of the invocations deviating by a predetermined amount and/or threshold from the predicted portion 276. For example, if the actual reports are less than the predicted portion 276 by the predetermined amount, an automatic and/or manual auditing process to evaluate the software usage may be executed, a notification provided to a user, automatic inquiries provided to users of the software application (e.g., “are you having difficulty with the application”) and tracking replies (e.g., “provider X has a cheaper software application and your software application has issues”) to the inquiries.

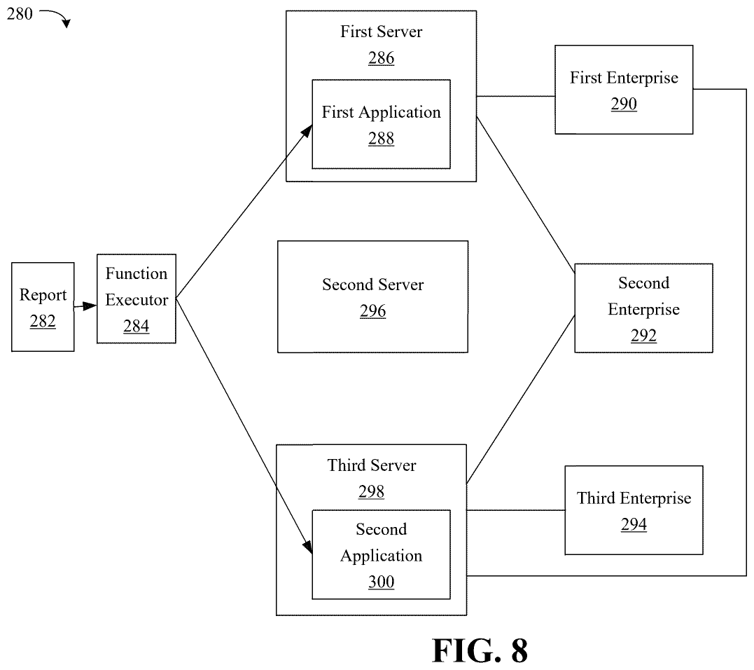

FIG. 8 illustrates an exemplary process 280 of determining hardware resource allocation based on usage data. The exemplary process 280 can generally be implemented in conjunction with any of the embodiments described herein, for example enhanced usage data tracking process 100 (FIGS. 1A-1B), load automation process 150 (FIG. 2), post-processing process 170 (FIG. 3), cost calculation process 220 (FIG. 4), invocation graph 240 (FIG. 5), user graph 260 (FIG. 6),) and/or invocation usage forecast 270. In detail, a report 282 is executed based on usage data. A function executor 284 can execute to determine usage data metrics and/or measurements. The usage data metrics and/or measurements can include whether certain enterprises are increasing usage and/or downloads of a particular application.

For example, some applications can execute in a cloud-based fashion. Thus, since some applications rely heavily on internet communications, positioning a copy of the application, processing logic, data storage and/or services associated with the application proximate to the enterprise can facilitate low-latency operations and reduce bandwidth. Furthermore, copies of the application can be stored proximate to such enterprises to facilitate low-latency downloads and reduce bandwidth. In such an instance, the usage data metrics and/or measurements can indicate that the forecast data, downloads and/or usage of the applications is above a threshold. As a consequence, the applications can be stored at a location proximate to a corresponding enterprise.

In this example, first usage data of a first application 288 is analyzed with the function executor 284. The function executor 284 can determine that the first enterprise 290 has a usage metric (e.g., number of invocations, users, increase in users and/or increase in a number of invocations) of the first application 288 that meets a threshold. Second and third usage metrics of second enterprise 292 and third enterprise 294 respectively can fail to meet the threshold. As such, the first application 288 can be stored at a first server 286 that is proximate to the first enterprise 290. For example, the first enterprise 290 can be closest to the first server 286 from the first server 286, second server 296 and third server 298. Thus, the first application 288 is stored at the first server 286. For example, the second enterprise 292 can use the first application 288 a reduced amount, and the third enterprise 294 can have no usage of the first application 288. Thus, the first server 286 can provide the first application 288 and/or operations of the first application 288 to the first enterprise 290 and the second enterprise 292.

The function executor 284 can further determine that a second application 300 is accessed by first enterprise 290, second enterprise 292 and third enterprise 294. The function executor 284 can determine that only the third enterprise 294 has a usage metric that meets the threshold, and thus stores second application 300 in the third server 298 to facilitate low latency access to the third enterprise 294. The third enterprise 294 can be closest to the third server 298 from the first server 286, second server 296 and third server 298. If, hypothetically, a usage metric of the second enterprise 292 with respect to the second application 300 also met the threshold, the second application 300 could also be stored in the second server 296, which is closest to the second enterprise 292 from the first enterprise 290, second enterprise 292 and third enterprise 294.

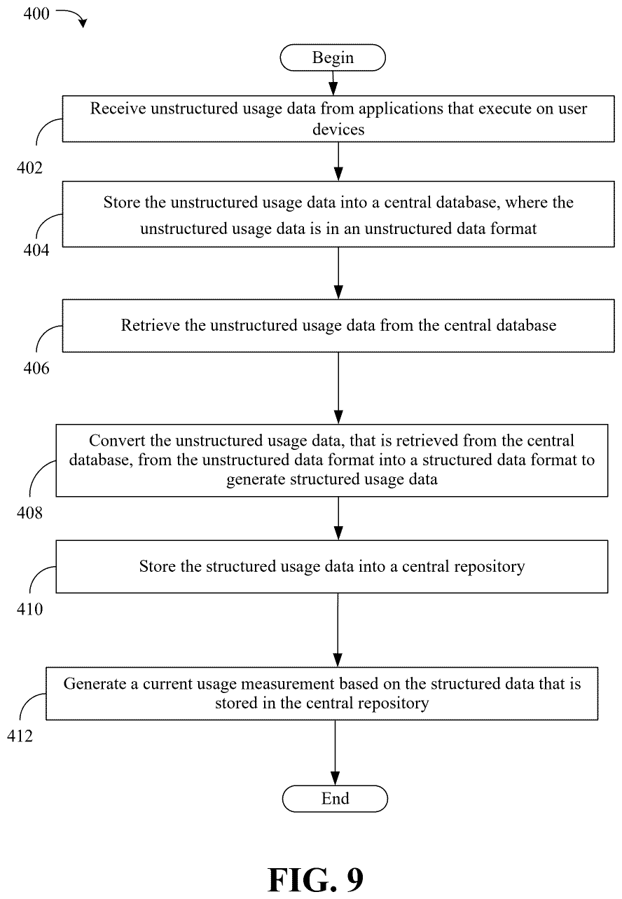

FIG. 9 illustrates a method 400 of implementing an enhanced teleservice session. The method 400 can generally be implemented in conjunction with any of the embodiments described herein, for example enhanced usage data tracking process 100 (FIGS. 1A-1B), load automation process 150 (FIG. 2), post-processing process 170 (FIG. 3), cost calculation process 220 (FIG. 4), invocation graph 240 (FIG. 5), user graph 260 (FIG. 6), invocation usage forecast 270 (FIG. 7) and/or exemplary process 280 (FIG. 8). In an embodiment, the method 400 is implemented in logic instructions (e.g., software), configurable logic, fixed-functionality hardware logic, computer readable instructions stored on at least one non-transitory computer readable storage medium that are executable to implement method 400, circuitry, etc., or any combination thereof.

Illustrated processing block 402 receives unstructured usage data from applications that execute on user devices. Illustrated processing block 404 stores the unstructured usage data into a central database, where the unstructured usage data is in an unstructured data format. Illustrated processing block 406 retrieves the unstructured usage data from the central database. Illustrated processing block 408 converts the unstructured usage data, that is retrieved from the central database, from the unstructured data format into a structured data format to generate structured usage data. Illustrated processing block 410 stores the structured usage data into a central repository. Illustrated processing block 412 generates a current usage measurement based on the structured data that is stored in the central repository. In some examples, the unstructured usage data corresponds to one or more of invocations of the applications or a number of users of the applications. In some examples, each of the second files is dedicated to a corresponding application of the applications. In some examples, the method 400 includes copying the unstructured usage data into a temporary database, and storing the structured usage data into the temporary database. The converting includes modifying the unstructured usage data that is stored in the temporary database.

In some examples, the method 400 includes generating a report based on the current usage measurement, generating a user interface based on the report, and presenting the user interface on a computing device, where the applications are executed on different enterprises. In some examples, the method 400 includes retrieving a first usage data from the central database based on an identification that the first usage data was previously unretrieved, bypassing second usage data for retrieval from the central database based on an identification that the second usage data was previously retrieved from the central database, predicting future usage of the applications based on the current usage measurement, and identifying hardware resources to support the applications based on the future usage measurement, where the first usage data is part of the unstructured data.

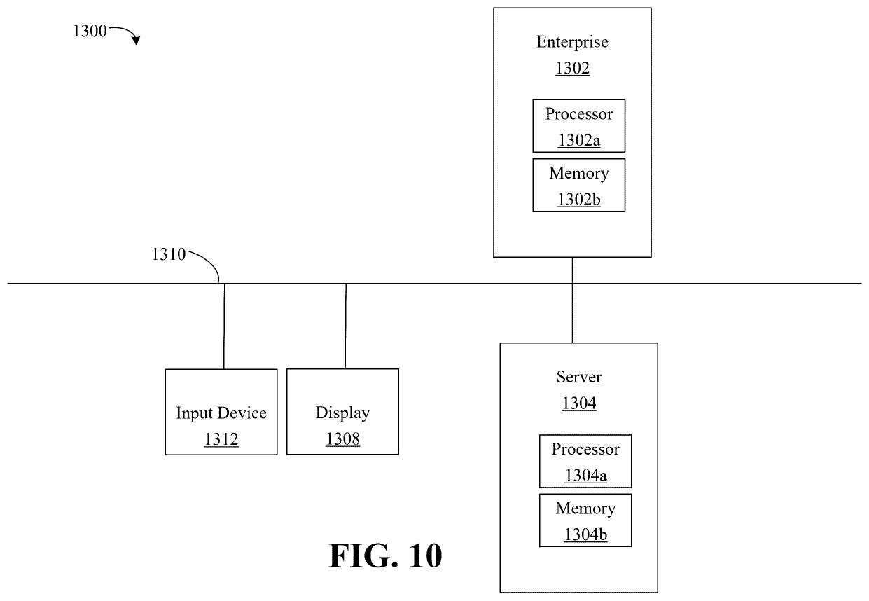

FIG. 10 shows a more detailed example of a computing system 1300 to execute an enhanced usage analysis. The computing system 1300 can generally be implemented in conjunction with any of the embodiments described herein, for example enhanced usage data tracking process 100 (FIGS. 1A-1B), load automation process 150 (FIG. 2), post-processing process 170 (FIG. 3), cost calculation process 220 (FIG. 4), invocation graph 240 (FIG. 5), user graph 260 (FIG. 6), invocation usage forecast 270, exemplary process 280 (FIG. 8) and/or method 400 (FIG. 9).

In the illustrated example, the computing system 1300 can include a network 1310 that can facilitate communication between the server 1304, enterprise 1302, display 1308 and input device 1312. The display 1308 (e.g., audio and/or visual interface) can present a browser, graphical user interface (GUI) to a user and can be connected with the server 1304 and/or enterprise 1302. The input device 1312 can receive user inputs (e.g., audio questions, keyboard typing, etc.).

The enterprise 1302 includes a processor 1302a (e.g., embedded controller, central processing unit/CPU) and a memory 1302b (e.g., non-volatile memory/NVM and/or volatile memory) containing a set of instructions, which when executed by the processor 1302a, cause the enterprise 1302 to implement aspects described herein, for example causing a computer to execute a telecommunication session and allow for bidirectional communication with a service provider. Multiple processors and memories can be provided.

The server 1304 includes a processor 1304a (e.g., embedded controller, central processing unit/CPU) and a memory 1304b (e.g., non-volatile memory/NVM and/or volatile memory) containing a set of instructions, which when executed by the processor 1304a, cause the server 1304 to implement aspects described herein, for example receive unstructured usage data from applications that execute on user devices, store the unstructured usage data into a central database, wherein the unstructured usage data is in an unstructured data format, retrieve the unstructured usage data from the central database, convert the unstructured usage data, that is retrieved from the central database, from the unstructured data format into a structured data format to generate structured usage data, store the structured usage data into a central repository, and generate a current usage measurement based on the structured data that is stored in the central repository.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

### Clauses

Clause 1. A computing system comprising: a processor; and a memory having a set of instructions, which when executed by the processor, cause the computing system to: receive unstructured usage data from applications that execute on user devices; store the unstructured usage data into a central database, wherein the unstructured usage data is in an unstructured data format; retrieve the unstructured usage data from the central database; convert the unstructured usage data, that is retrieved from the central database, from the unstructured data format into a structured data format to generate structured usage data; store the structured usage data into a central repository; and generate a current usage measurement based on the structured usage data that is stored in the central repository.

Clause 2. The computing system of clause 1, wherein the unstructured usage data corresponds to one or more of invocations of the applications or a number of users of the applications.

Clause 3. The computing system of any one of clauses 1 to 2, wherein the structured usage data is divided into files that are each dedicated to a corresponding application of the applications.

Clause 4. The computing system of any one of clauses 1 to 3, wherein the instructions of the memory, when executed, cause the computing system to: copy the unstructured usage data into a temporary database; and store the structured usage data into the temporary database, wherein to convert the unstructured usage data from the unstructured data format into the structured data format, the set of instructions, which when executed by the computing system, cause the computing system to modify the unstructured usage data that is stored in the temporary database.

Clause 5. The computing system of any one of clauses 1 to 4, wherein the instructions of the memory, when executed, cause the computing system to: generate a report based on the current usage measurement; generate a user interface based on the report; and present the user interface on a computing device, wherein the applications are executed on different enterprises.

Clause 6. The computing system of any one of clauses 1 to 5, wherein the instructions of the memory, when executed, cause the computing system to: retrieve a first usage data from the central database based on an identification that the first usage data was previously unretrieved; and bypass second usage data for retrieval from the central database based on an identification that the second usage data was previously retrieved from the central database, wherein the first usage data is part of the unstructured data.

Clause 7. The computing system of any one of clauses 1 to 6, wherein the instructions of the memory, when executed, cause the computing system to: predict future usage of the applications based on the current usage measurement; and identify hardware resources to support the applications based on the future usage measurement.

Clause 8. At least one non-transitory computer readable storage medium comprising a set of instructions, which when executed by a computing system, cause the computing system to: receive unstructured usage data from applications that execute on user devices; store the unstructured usage data into a central database, wherein the unstructured usage data is in an unstructured data format; retrieve the unstructured usage data from the central database; convert the unstructured usage data, that is retrieved from the central database, from the unstructured data format into a structured data format to generate structured usage data; store the structured usage data into a central repository; and generate a current usage measurement based on the structured usage data that is stored in the central repository.

Clause 9. The at least one non-transitory computer readable storage medium of clause 8, wherein the unstructured usage data corresponds to one or more of invocations of the applications or a number of users of the applications.

Clause 10. The at least one non-transitory computer readable storage medium of any one of clauses 8 to 9, wherein the structured usage data is divided into files that are each dedicated to a corresponding application of the applications.

Clause 11. The at least one non-transitory computer readable storage medium of any one of clause 8 to 10, wherein the instructions, when executed, cause the computing system to: copy the unstructured usage data into a temporary database; and store the structured usage data into the temporary database, wherein to convert the unstructured usage data from the unstructured data format into the structured data format, the set of instructions, which when executed by the computing system, cause the computing system to modify the unstructured usage data that is stored in the temporary database.

Clause 12. The at least one non-transitory computer readable storage medium of any one of clause 8 to 11, wherein the instructions, when executed, cause the computing system to: generate a report based on the current usage measurement; generate a user interface based on the report; and present the user interface on a computing device, wherein the applications are executed on different enterprises.

Clause 13. The at least one non-transitory computer readable storage medium of any one of clause 8 to 12, wherein the instructions, when executed, cause the computing system to: retrieve first usage data from the central database based on an identification that the first usage data was previously unretrieved; and bypass second usage data for retrieval from the central database based on an identification that the second usage data was previously retrieved from the central database, wherein the first usage data is part of the unstructured data.

Clause 14. The at least one non-transitory computer readable storage medium of any one of clause 8 to 13, wherein the instructions, when executed, cause the computing system to: predict future usage of the applications based on the current usage measurement; and identify hardware resources to support the applications based on the future usage measurement.

Clause 15. A method comprising: receiving unstructured usage data from applications that execute on user devices; storing the unstructured usage data into a central database, wherein the unstructured usage data is in an unstructured data format; retrieving the unstructured usage data from the central database; converting the unstructured usage data, that is retrieved from the central database, from the unstructured data format into a structured data format to generate structured usage data; storing the structured usage data into a central repository; and generating a current usage measurement based on the structured usage data that is stored in the central repository.

Clause 16. The method of clause 15, wherein the unstructured usage data corresponds to one or more of invocations of the applications or a number of users of the applications.

Clause 17. The method of any one of clause 15 to 16, wherein the structured usage data is divided into files that are each dedicated to a corresponding application of the applications.

Clause 18. The method of any one of clause 15 to 17, comprising: copying the unstructured usage data into a temporary database; and storing the structured usage data into the temporary database, wherein the converting includes modifying the unstructured usage data that is stored in the temporary database.

Clause 19. The method of any one of clause 15 to 18, further comprising: generating a report based on the current usage measurement; generating a user interface based on the report; and presenting the user interface on a computing device, wherein the applications are executed on different enterprises.

Clause 20. The method of any one of clause 15 to 19, comprising: retrieving a first usage data from the central database based on an identification that the first usage data was previously unretrieved; bypassing second usage data for retrieval from the central database based on an identification that the second usage data was previously retrieved from the central database; predicting future usage of the applications based on the current usage measurement; and identifying hardware resources to support the applications based on the future usage measurement, wherein the first usage data is part of the unstructured data.

We claim:

1. A computing system comprising:
a processor; and
a memory having a set of instructions, which when executed by the processor, cause the computing system to:
receive unstructured usage data from applications that execute on user devices;
store the unstructured usage data into a central database, wherein the unstructured usage data is in an unstructured data format;
retrieve the unstructured usage data from the central database;
convert the unstructured usage data, that is retrieved from the central database, from the unstructured data format into a structured data format to generate structured usage data;
store the structured usage data into a central repository; and
generate a current usage measurement based on the structured usage data that is stored in the central repository.

2. The computing system of claim 1, wherein the unstructured usage data corresponds to one or more of invocations of the applications or a number of users of the applications.

3. The computing system of claim 1, wherein the structured usage data is divided into files that are each dedicated to a corresponding application of the applications.

4. The computing system of claim 1, wherein the instructions of the memory, when executed, cause the computing system to:
copy the unstructured usage data into a temporary database; and
store the structured usage data into the temporary database,
wherein to convert the unstructured usage data from the unstructured data format into the structured data format, the set of instructions, which when executed by the computing system, cause the computing system to modify the unstructured usage data that is stored in the temporary database.

5. The computing system of claim 1, wherein the instructions of the memory, when executed, cause the computing system to:
generate a report based on the current usage measurement;
generate a user interface based on the report; and
present the user interface on a computing device,
wherein the applications are executed on different enterprises.

6. The computing system of claim 1, wherein the instructions of the memory, when executed, cause the computing system to:
retrieve a first usage data from the central database based on an identification that the first usage data was previously unretrieved; and
bypass second usage data for retrieval from the central database based on an identification that the second usage data was previously retrieved from the central database,
wherein the first usage data is part of the unstructured data.

7. The computing system of claim 1, wherein the instructions of the memory, when executed, cause the computing system to:
predict future usage of the applications based on the current usage measurement; and
identify hardware resources to support the applications based on the future usage measurement.

8. At least one non-transitory computer readable storage medium comprising a set of instructions, which when executed by a computing system, cause the computing system to:
receive unstructured usage data from applications that execute on user devices;
store the unstructured usage data into a central database, wherein the unstructured usage data is in an unstructured data format;
retrieve the unstructured usage data from the central database;
convert the unstructured usage data, that is retrieved from the central database, from the unstructured data format into a structured data format to generate structured usage data;
store the structured usage data into a central repository; and
generate a current usage measurement based on the structured usage data that is stored in the central repository.

9. The at least one non-transitory computer readable storage medium of claim 8, wherein the unstructured usage data corresponds to one or more of invocations of the applications or a number of users of the applications.

10. The at least one non-transitory computer readable storage medium of claim 8, wherein the structured usage data is divided into files that are each dedicated to a corresponding application of the applications.

11. The at least one non-transitory computer readable storage medium of claim 8, wherein the instructions, when executed, cause the computing system to:
copy the unstructured usage data into a temporary database; and
store the structured usage data into the temporary database,
wherein to convert the unstructured usage data from the unstructured data format into the structured data format, the set of instructions, which when executed by the computing system, cause the computing system to modify the unstructured usage data that is stored in the temporary database.

12. The at least one non-transitory computer readable storage medium of claim 8, wherein the instructions, when executed, cause the computing system to:
generate a report based on the current usage measurement;
generate a user interface based on the report; and
present the user interface on a computing device,
wherein the applications are executed on different enterprises.

13. The at least one non-transitory computer readable storage medium of claim 8, wherein the instructions, when executed, cause the computing system to:
retrieve first usage data from the central database based on an identification that the first usage data was previously unretrieved; and
bypass second usage data for retrieval from the central database based on an identification that the second usage data was previously retrieved from the central database,
wherein the first usage data is part of the unstructured data.

14. The at least one non-transitory computer readable storage medium of claim 8, wherein the instructions, when executed, cause the computing system to:
predict future usage of the applications based on the current usage measurement; and
identify hardware resources to support the applications based on the future usage measurement.

15. A method comprising:
receiving unstructured usage data from applications that execute on user devices;
storing the unstructured usage data into a central database, wherein the unstructured usage data is in an unstructured data format;
retrieving the unstructured usage data from the central database;
converting the unstructured usage data, that is retrieved from the central database, from the unstructured data format into a structured data format to generate structured usage data;
storing the structured usage data into a central repository; and
generating a current usage measurement based on the structured usage data that is stored in the central repository.

16. The method of claim 15, wherein the unstructured usage data corresponds to one or more of invocations of the applications or a number of users of the applications.

17. The method of claim 15, wherein the structured usage data is divided into files that are each dedicated to a corresponding application of the applications.

18. The method of claim 15, comprising:
copying the unstructured usage data into a temporary database; and
storing the structured usage data into the temporary database,
wherein the converting includes modifying the unstructured usage data that is stored in the temporary database.

19. The method of claim 15, further comprising:
generating a report based on the current usage measurement;
generating a user interface based on the report; and
presenting the user interface on a computing device,
wherein the applications are executed on different enterprises.

20. The method of claim 15, comprising:
retrieving a first usage data from the central database based on an identification that the first usage data was previously unretrieved;
bypassing second usage data for retrieval from the central database based on an identification that the second usage data was previously retrieved from the central database;
predicting future usage of the applications based on the current usage measurement; and
identifying hardware resources to support the applications based on the future usage measurement,
wherein the first usage data is part of the unstructured data.
